(19) United States
(12) Patent Application Publication
(10) Pub. No.: US 2025/0033587 A1
(43) Pub. Date: Jan. 30, 2025

(54) VEHICLE FRONT STRUCTURE

(71) Applicant: HONDA MOTOR CO., LTD., Tokyo (JP)

(72) Inventors: Yuki SASANUMA, Tokyo (JP); Tomoya YABU, Tokyo (JP); Teruaki AIZAWA, Tokyo (JP)

(21) Appl. No.: 18/780,626

(22) Filed: Jul. 23, 2024

(30) Foreign Application Priority Data
Jul. 28, 2023 (JP) 2023-123415

(51) Int. Cl. B60R 19/18

(52) U.S. Cl. CPC B60R 19/18; B60R 2019/1813

(57) ABSTRACT

The objective is to suppress function impairment of a detection device during a light collision. A vehicle front structure includes a bumper reinforcement, a bracket, and a detection device. The bumper reinforcement extends in a vehicle-width direction at a front part of the vehicle. The bracket is attached to an end in the vehicle-width direction of a front part of the vehicle. The detection device is attached to the bracket, and detects objects obliquely ahead of the vehicle. An end on the vehicle-width direction inside of the detection device is located more to the vehicle-width direction inside than an end on the vehicle-width direction outside of the bumper reinforcement.

This application is based on and claims the benefit of priority from Japanese Patent Application No. 2023-123415, filed on 28 Jul. 2023, the content of which is incorporated herein by reference.

### BACKGROUND OF THE INVENTION

### Field of the Invention

The present invention relates to a vehicle front structure.

### Related Art

In recent years, efforts are becoming more active to provide access to a sustainable transportation system made taking account of vulnerable people among traffic participants. Directed to this realization, the present applicant has focused on further improving the safety and convenience of traffic, through research and development relating to driving aid technology.

Among the vehicle front structure including a detection device such as radar used in driving aid technology, there are those configured as follows. In other words, the vehicle front structure includes lamps, a bumper reinforcement, detection devices and brackets. The bumper reinforcement extends in the vehicle-width direction at the front of the vehicle. The detection device is provided at the end in the vehicle-width direction at the front of the vehicle, and monitors obliquely ahead of the vehicle.
Patent Document 1: Japanese Unexamined Patent Application, Publication No. 2021-91303

### SUMMARY OF THE INVENTION

In the laws and regulations of each country and each region around the world, it may be demanded for detection devices not to have function impairment occur by light collision of the vehicle. This function impairment, for example, includes failure of the detection device itself, and angular displacement of the detection device to an extent that it is no longer possible to normally use the detection device.

The present invention has been made taking the above-mentioned situation into account, and has an object of suppressing function impairment of the detection device during light collision of the vehicle.

The present inventors have found that it is possible to achieve the above object if the end in the vehicle-width direction inside of the detection device is positioned more to the inner side in the vehicle-width direction than an end on a vehicle-width direction outer side of the bumper reinforcement, thereby arriving at the present invention. The present invention is a vehicle front structure of the following (1) to (4).

(1) A vehicle front structure includes:
a bumper reinforcement which extends in a vehicle-width direction at a front end of a vehicle;
a bracket which is attached to an end in a vehicle-width direction of a front part of the vehicle; and
a detection device which is attached to the bracket, and detects an object obliquely ahead of the vehicle,
wherein an end on the vehicle-width direction inside of the detection device is located more to the vehicle-width direction inside than an end on a vehicle-width direction outside of the bumper reinforcement.

According to the present configuration, an end on the vehicle-width direction inside of the detection device is located more to the vehicle-width direction inside than an end on the vehicle-width direction outside of the bumper reinforcement; therefore, the detection device tends to be protected by the bumper reinforcement during a light collision. It is thereby possible to suppress function impairment of the detection device during light collision of the vehicle.

(2) The vehicle front structure according to (1) above, wherein, viewing from a front side of the vehicle, the detection device is provided at a position distanced upwards from an end on the vehicle-width direction outside of the bumper reinforcement.

According to the present configuration, since the detection device is distanced upwards from the bumper reinforcement, even if force acts on the bumper reinforcement due to a light collision; this force acts so as to penetrate below the detection device. For this reason, there is no concern over the detection device being sandwiched between the bumper reinforcement and a member rearward of the detection device. For this reason, it is possible to more strongly suppress function impairment of the detection device during the occurrence of a light collision.

(3) The vehicle front structure according to (2) above, wherein the bracket is attached to a portion located above the detection device of the front part of the vehicle.

According to the present configuration, since the detection device is supported to a portion located above the detection device via a bracket; it tends to better fend off the effect of the force acting from the bumper reinforcement below the detection device during a light collision. For this reason, it is possible to more strongly suppress function impairment of the detection device during the occurrence of a light collision.

(4) The vehicle front structure according to (1) or (2) above, wherein, viewing from above, the detection device is provided at a position distanced rearwards from an end in the vehicle-width direction of the bumper reinforcement.

According to the present configuration, compared to a case of a part of the detection device overlapping the bumper reinforcement viewing from above, the detection device tends to be more strongly protected by the bumper reinforcement. For this reason, it is possible to more strongly suppress function impairment of the detection device during the occurrence of a light collision.

According to the configuration of (1), it is possible to suppress function impairment of the detection device during a light collision of the vehicle. Furthermore, according to the configurations of (2) to (4) citing (1), each of the additional effects can be obtained.

### BRIEF DESCRIPTION OF THE DRAWINGS

FIG. 1 is a side view showing a front part of a vehicle from the left;

FIG. 2 is a perspective view showing the front part of a vehicle from the left front;

FIG. 3 is a front view showing the front part of a vehicle from the front;

FIG. 4 is a plan view showing the front part of a vehicle from above;

FIG. 5 is a view showing a cross section along the line V-V shown in FIG. 4; and

FIG. 6 is a perspective view showing a bracket and detection device obliquely from below and the right rear.

### DETAILED DESCRIPTION OF THE INVENTION

Hereinafter, embodiments of the present invention will be explained while referencing the drawings. However, the present invention is not to be limited in any way to the following embodiments, and can be implemented by modifying where appropriate within a scope not departing from the gist of the present invention.

### First Embodiment

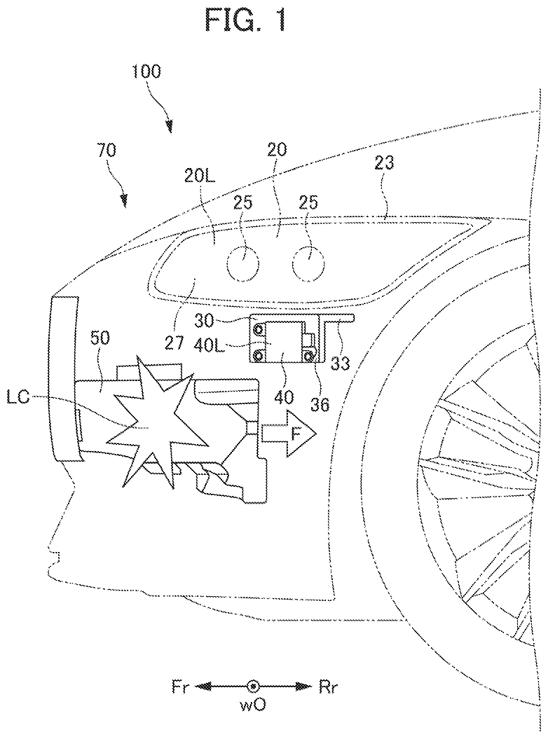

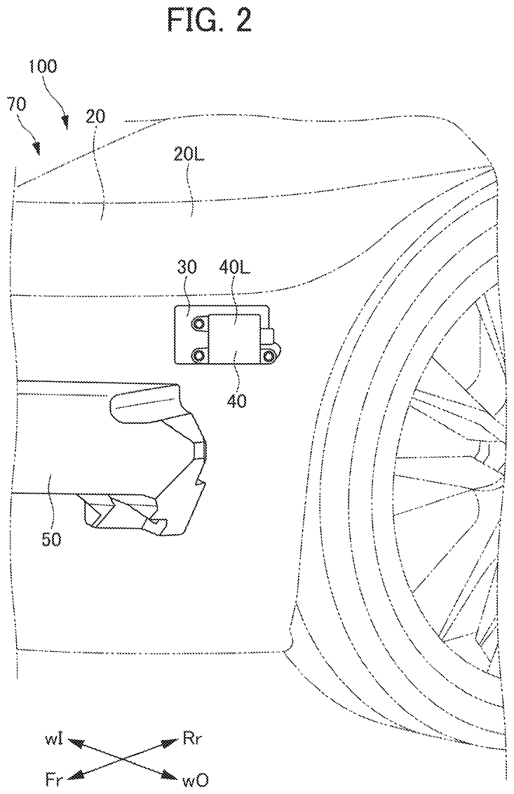

A vehicle front structure 70 is the structure of a front part of a vehicle 100, as shown in FIG. 1. Hereinafter, a front side of the vehicle 100 is referred to as “front Fr”, and a rear side of the vehicle 100 is referred to as “rear Rr”, as shown in FIG. 2. In addition, an inner side in a vehicle width direction of the vehicle 100 is referred to as “vehicle-width direction inside wI”, and an outer side in the vehicle width direction of the vehicle 100 is referred to as “vehicle-width direction outside wO”.

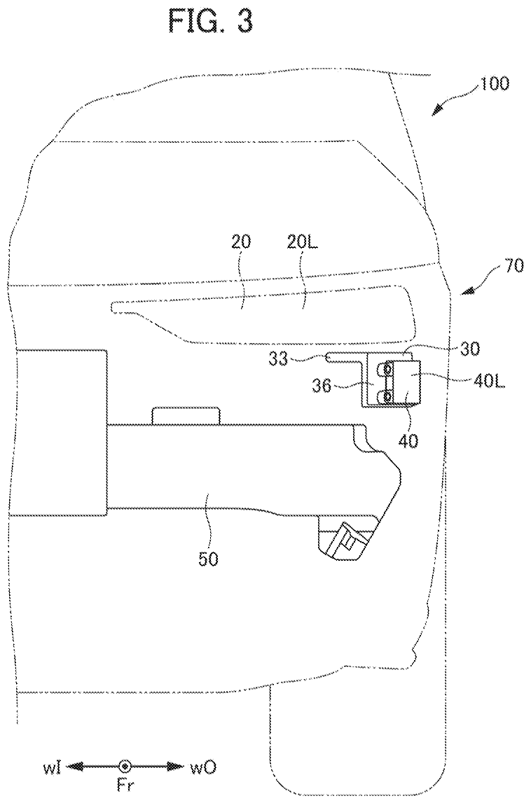

As shown in FIG. 3, the vehicle front structure 70 includes: a lamp 20, a bracket 30, a detection device 40, and a bumper reinforcement 50. The lamp 20 includes a right-side headlight (not illustrated), and left-side headlight 20L. It should be noted that, in FIGS. 1 to 6, although only the left part of the vehicle front structure 70 is shown, the right part is a left/right reflection of the left part and is similar.

As shown in FIG. 1, the lamp 20 includes a light source 25, housing 23 and outer lens 27. The housing 23 is a shape in which the front Fr side is released, and accommodates the light source 25 inside thereof. The outer lens 27 is a transparent body which covers the housing 23 from the front Fr side.

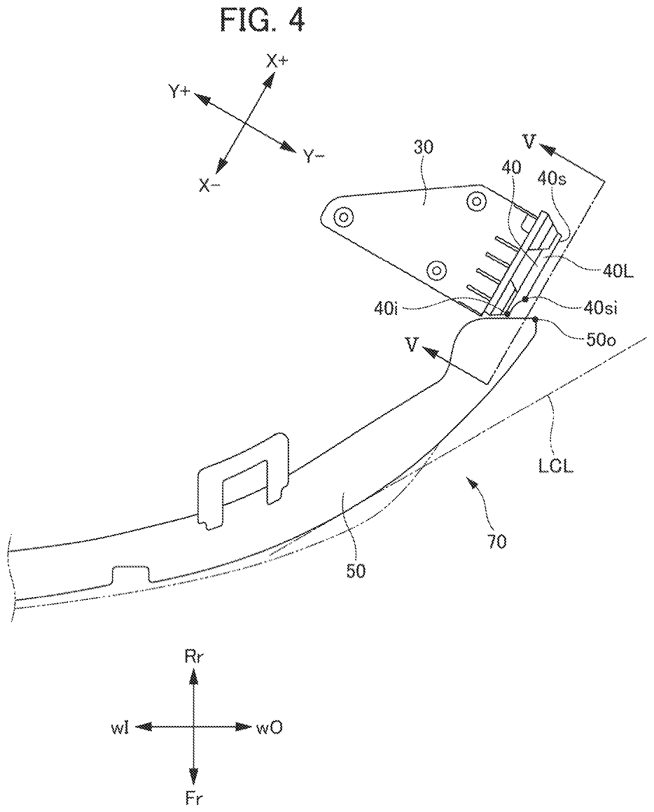

As shown in FIG. 4, the bumper reinforcement 50 extends to the vehicle width directions wI, wO at the front end of the vehicle front structure 70. The bumper reinforcement 50 is made from metal, and does not transmit radio waves. One detection device 40 is provided at each of both ends in the vehicle width directions wI, wO of the front part of the vehicle 100. Therefore, as the detection device 40, a right-side detection device (not illustrated), and left-side detection device 40L are present.

Hereinafter, as shown in FIG. 4, a direction of diagonal front Fr between the front Fr and vehicle-width outside wO is referred to as “Y− direction”, and the opposite direction thereto is referred to as “Y+ direction”. In addition, the Y− direction and Y+ direction are collectively referred to as “Y direction”. In addition, hereinafter, a direction orthogonal to the Y direction in a horizontal plane is referred to as “X direction”. In addition, a direction near the vehicle width direction inside wI of the X direction is referred to as “X− direction”, and the opposite side thereto is referred to as “X+ direction”.

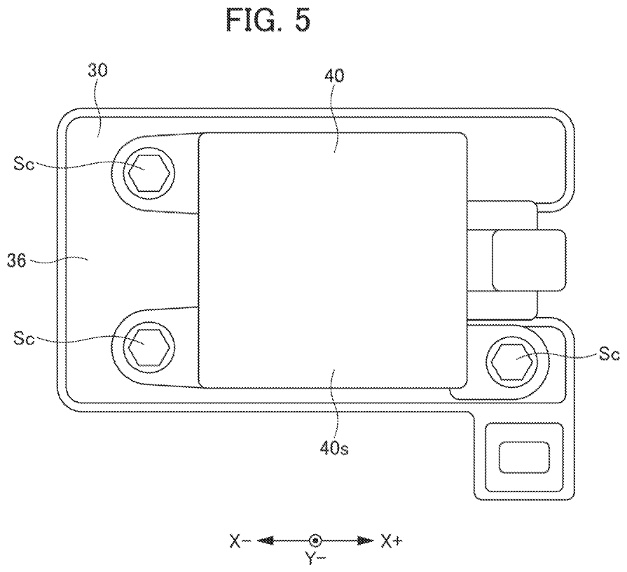

As shown in FIG. 5, the detection device 40 establishes a plate shape extending in the up/down direction and X direction, and the end face on the Y− direction side constitutes a proximity surface 40s. Therefore, the normal direction to the detection surface 40s is the Y direction. The detection device 40 is a radar device, and irradiates radio waves from the detection surface 40s to the Y− direction side, and detects the reflected waves thereof by the detection surface 40s. The detection device 40 shown in FIG. 4 thereby detects objects on the Y− direction side. More to the Y− direction side than the detection device 40, a cover (not illustrated) which passes radio waves made of resin or the like is attached.

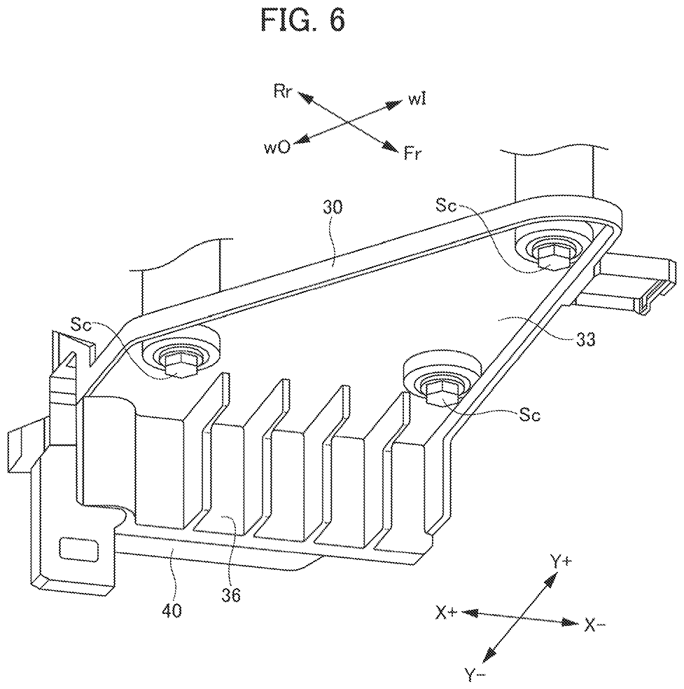

As shown in FIG. 6, the bracket 30 has a horizontal part 33 and vertical part 36. The horizontal part 33 is a plate shape extending in the Y direction and X direction. The horizontal part 33 is attached to a portion of a front part of the vehicle 100 located more upwards than the detection device 40, by screws Sc or the like. More specifically, in the present embodiment, the horizontal part 33 of the bracket 30 is attached to the lower face of the housing 23 of the lamp 20.

The vertical part 36 is a plate shape extending in the X direction and up/down direction, and projects downwards from the end in the Y− direction of the horizontal part 33. The detection device 40 is attached at the surface of this vertical part 36 on the side of the Y− direction by screws Sc or the like, as shown in FIG. 5. As shown in FIG. 6, the detection device 40 is thereby supported by a portion of the front part of the vehicle 100 located above this detection device 40, via the bracket 30.

Viewing from the front Fr as shown in FIG. 3, each detection device 40 is provided to a position distanced upwards from the end on the vehicle width direction outside wO of the bumper reinforcement 50.

Viewing from above as shown in FIG. 4, the detection device 40 is provided more inwards than a light collision line CL, that is at a position entering to the Y+ direction side. The light collision line cL, viewing from above, is a line forming 30 degrees relative to the vehicle-width direction wO, wI, and contacting a front surface of the bumper reinforcement 50. More specifically, viewing from above, the detection device 40 is provided at a position distance to the rear Rr from an end on the vehicle-width direction outside wO of the bumper reinforcement 50.

An end 40i of the vehicle-width direction inside wI of the detection device 40 is positioned more to the vehicle-width direction inside wI than an end 500 of the vehicle-width direction outside wO of the bumper reinforcement 50. In more detail, the end 40si of the vehicle-width direction inside wI of the detection surface 40s is also positioned more to the vehicle-width direction inside wI than the end 500 of the vehicle-width direction outside wO of the bumper reinforcement 50.

Hereinafter, the configuration and effects of the present embodiment will be summarized.

As shown in FIG. 4, the end 40i of the vehicle-width direction inside wI of the detection device 40 is positioned more to the vehicle-width direction inside wI than the end 500 of the vehicle-width direction outside wO of the bumper reinforcement 50. For this reason, during the occurrence of a light collision LC, the detection device 40 tends to be protected by the bumper reinforcement 50. It is thereby possible to suppress function impairment of the detection device 40 during the occurrence of a light collision LC of the vehicle 100.

Moreover, as shown in FIG. 1, the detection device 40 distances upwards from the bumper reinforcement 50. For this reason, even if a force F acts on the bumper reinforcement 50 by the light collision LC, this force F acts so as to penetrate below the detection device 40. For this reason, there is no concern over the detection device 40 being sandwiched between the bumper reinforcement 50 and a member behind the detection device 40. For this reason, it is possible to more strongly suppress function impairment of the detection device 40 during the occurrence of a light collision LC.

In addition, in a test imitating an actual light collision LC, more specifically, a pendulum test applying shock to the bumper reinforcement 50, for example, similarly to as mentioned above, the detection device 40 hardly receives function impairment, and thus more easily passes the test.

In addition, by the detection device 40 distancing upwards from the bumper reinforcement 50 in this way, the radio waves irradiated from the detection surface 40s and reflected waves returned to the detection surface 40s are hardly blocked by the bumper reinforcement. For this reason, the detection of objects is possible over a wide angle.

Furthermore, as shown in FIG. 6, the bracket 30 supports the detection device 40 to a portion located above this detection device 40. For this reason, as shown in FIG. 1, the detection device 40 tends to better fend off the effect of the force F acting from the bumper reinforcement 50 below the detection device 40 during a light collision. For this reason, it is possible to more strongly suppress function impairment of the detection device 40 during the occurrence of a light collision LC.

Viewing from above as shown in FIG. 4, the detection device 40 is distanced rearwards from the bumper reinforcement 50. For this reason, compared to a case of a part of the detection device 40 overlapping the bumper reinforcement 50 viewing from above, the detection device 40 tends to be more strongly protected by the bumper reinforcement 50. For this reason, it is possible to more strongly suppress function impairment of the detection device 40 during the occurrence of a light collision LC.

### Other Embodiments

The embodiment illustrated above can be modified as follows, for example.

In a plan view shown in FIG. 4, if it will not be much of a problem even if the front end of the detection device 40 overlaps the bumper reinforcement 50, they may overlap. In the case that it will not be much of a problem even if the bracket 30 attached to a portion such as that located on the Y+ direction side or X direction side, rather than to the portion located above the detection device 40 of the vehicle 100, the bracket 30 shown in FIG. 6 may be attached to these portions.

In the front view shown in FIG. 3, if it will not be much of a problem even if the lower end of the detection device 40 overlaps the bumper reinforcement 50, it may overlap. The detection device 40 may be a sonar device. In other words, the detection device 40 may irradiate sound waves from the detection surface 40s to the Y− direction side, and detect the reflected waves by the detection surface 40s.

### EXPLANATION OF REFERENCE NUMERALS

30 bracket
40 detection device
40i end on vehicle-width direction inside of detection device
50 bumper reinforcement
500 end on vehicle-width direction outside of bumper reinforcement
70 vehicle front structure
100 vehicle
Fr front
wI vehicle-width direction inside
wO vehicle-width direction outside
Rr rear

What is claimed is:

1. A vehicle front structure comprising:
a bumper reinforcement which extends in a vehicle-width direction at a front end of a vehicle;
a bracket which is attached to an end in a vehicle-width direction of a front part of the vehicle; and
a detection device which is attached to the bracket, and detects an object obliquely ahead of the vehicle,
wherein an end on the vehicle-width direction inside of the detection device is located more to the vehicle-width direction inside than an end on a vehicle-width direction outside of the bumper reinforcement.

2. The vehicle front structure according to claim 1, wherein, viewing from a front side of the vehicle, the detection device is provided at a position distanced upwards from an end on the vehicle-width direction outside of the bumper reinforcement.

3. The vehicle front structure according to claim 2, wherein the bracket is attached to a portion located above the detection device of the front part of the vehicle.

4. The vehicle front structure according to claim 1, wherein, viewing from above, the detection device is provided at a position distanced rearwards from an end in the vehicle-width direction of the bumper reinforcement.
